(19) United States
(12) Patent Application Publication
(10) Pub. No.: US 2008/0297068 A1
(43) Pub. Date: Dec. 4, 2008

(54) Method and System for Lighting Control

(75) Inventors: Paul Koren, Altamonte Springs, FL (US); Stephen Faber, Orlando, FL (US); Roy Archer, Orlando, FL (US); Michael Bauer, Orlando, FL (US)

Correspondence Address: AKERMAN SENTERFITT, P.O. BOX 3188, WEST PALM BEACH, FL, 33402-3188, US

(73) Assignee: Nexxus Lighting, Inc., Orlando, FL (US)

(21) Appl. No.: 11/757,009

(22) Filed: Jun. 1, 2007

(51) Int. Cl. H05B 37/02

(52) U.S. Cl. 315/297; 315/307

(57) ABSTRACT

A system and method for controlling an entertainment system is provided. The system can have at least one light source to generate variable light output and at least one controller coupled to the at least one light source to control the variable light output based on a number of interruptions of power supplied to the apparatus over a pre-determined time period. The variable light output can be a light temperature. The at least one light source can be a plurality of light sources, with the at least one controller having a plurality of addresses and each of the addresses designating one or more of the plurality of light sources to be controlled. The at least one controller can synchronize or unsynchronize the plurality of light sources.

### FIELD OF THE INVENTION

This invention is directed generally to methods and systems for control and, more particularly, to methods and systems for controlling an entertainment and/or lighting system.

### BACKGROUND OF THE INVENTION

Coordinated light and sound displays using outdoor lighting are known in commercial applications. For example, hotels and shopping malls may have installed lighting in fountains or spotlighting distinctive features, which can change color along with music. Such lighting systems are very expensive and difficult to install and maintain, and are not suitable for use in a domestic setting, such as in the yard or garden of a home.

It is also known to use fiber-optic cables for underwater lighting, which can be used to provide changing lighting colors in a domestic swimming pool, but fiber-optic lighting is expensive and difficult to install, and is not suitable for the retrofitting of existing pools. Additionally, the fiber-optic light fixtures are not as bright as traditional incandescent light fixtures, and are therefore not well used in pool and other underwater lighting applications.

In contrast to traditional light sources, solid state lighting, such as light emitting diode (“LED”) fixtures, are more efficient at generating visible light than many traditional light sources. However, single LED lights are typically not bright enough for illuminating objects or for use in pool and other underwater lighting. In order to use LEDs for illumination, a cluster of LED fixtures must be provided. Although LEDs do not generally radiate heat in the direction of the beam of light produced, implementation of LEDs for many traditional light source applications has been hindered by the amount of heat build-up within the electronic circuits of the LEDs. This heat build-up is particularly problematic as more LEDs are added to a cluster. Heat build-up reduces LED light output, shortens lifespan and can eventually cause the LEDs to fail. It has therefore been problematic to use LED lights to provide light and sound displays in an outdoor setting.

LED light engines have recently become available, which supply multiple LED lights in an array. The light engines make it possible to provide a high lumen light using LEDs, and it is desirable to use such light engines in swimming pool, spa and other underwater lighting. However, the management of heat generated by the light engines is critical to maintaining the performance of the LED array, and the use of such LED light engines in different applications has not so far been achieved.

Control of the various light fixtures is typically through a pre-determined scheme, such as a light show or symphony. Individual control of light fixtures often requires hardwiring of a control mechanism with the fixture. Such control mechanisms are often complex and the ability to control the feature is often difficult for the user because of the complexity, for example, numerous buttons to control each fixture.

It is desirable to provide both light fixtures, such as spotlights, flood lights and pool lights, using LED light engines, and also to provide methods and systems for controlling multiple LED light fixtures to provide coordinated light and sound displays. It is further desirable to provide a control system that is easily operated, while providing flexibility in the control that is exerted on the lighting fixtures or other components of the entertainment and/or lighting system.

### SUMMARY OF THE INVENTION

The exemplary embodiments provide a control system for one or more light fixtures and/or one or more other components of the lighting system that is easy to operate. The control system can be used with various types of light fixtures and/or other components of the lighting system. The control system provides flexibility in the type of control being exerted.

In one aspect, the present invention provides a lighting system having at least one light source to generate variable light output; and at least one controller coupled to the at least one light source to control the variable light output based on a number of interruptions of power supplied to the at least one light source over a pre-determined time period.

In another aspect, a method of controlling output in an entertainment system having at least one entertainment device is provided. The method includes providing power to the at least one entertainment device; interrupting the power a number of times; monitoring the entertainment device to determine a number of power interruptions over a pre-determined time period; and varying the output of the entertainment device based upon the number of power interruptions over the pre-determined time period.

In another aspect, a lighting device for a lighting system is provided. The device has a light engine coupled to a power source and capable of providing variable light output; a controller connected to the light engine and in communication with the power source for detecting a number of power interruptions over a pre-determined time period. The controller varies the light output of the light engine based at least in part on the number of power interruptions over the pre-determined time period.

These and other arrangements and advantages are described in relation to the accompanying drawings.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is an exemplary schematic of the arrangement for the components of a lighting system according to the inventive arrangements.

FIG. 2 is flow diagram for an exemplary embodiment of a control system for controlling a light fixture of the system of FIG. 1.

FIG. 3 is flow diagram for an exemplary embodiment of a control system for controlling multiple components of the lighting system of FIG. 1.

FIG. 4 is flow diagram for another exemplary embodiment of a control system for controlling multiple components of the lighting system of FIG. 1.

FIG. 5 is an exemplary embodiment of a power and control circuit for use with the control system of FIG. 2.

FIG. 6 is an exemplary embodiment of a power and control circuit for use with the control system of FIG. 2.

FIG. 7 is an exemplary embodiment of a power and control circuit for use with the control system of FIG. 3.

FIG. 8 is an exemplary embodiment of a power and control circuit for use with the control system of FIG. 4.

### DETAILED DESCRIPTION OF INVENTION

The exemplary embodiments provide light fixtures, such as light emitting diode (LED) fixtures, and provide methods and system for controlling the light fixtures. The exemplary embodiments also provide other components of lighting or entertainment systems, such as fans and music generating devices, and provide methods and system for controlling the other components. The embodiments of the present disclosure can be used for the provision and control of landscaping lighting, for example using pool, spa and other water feature lights in combination with spotlights and floodlights illuminating landscape fixtures, trees and other plants and buildings.

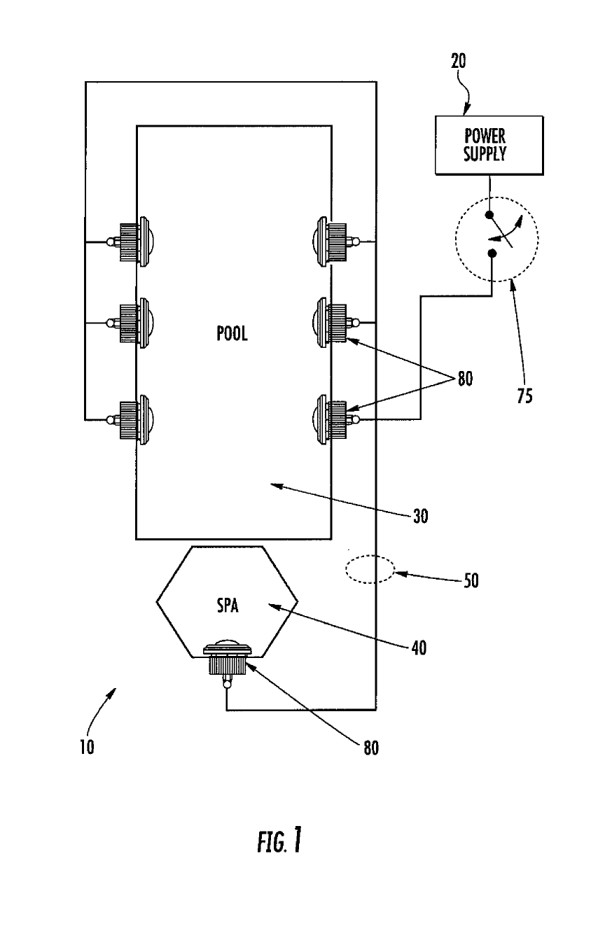

Controlling the light output of one or more light fixtures, including varying the light output between two or more of the light fixtures, can be accomplished by using existing wiring which provides varying illumination in multiple areas without the use of the control console. The present disclosure describes control of light fixtures. However, the control systems described herein can also control other devices, such as water features or sound generating devices. For example, as shown in FIG. 1, a lighting system 10 can include a power supply 20 providing power to both a first area 30, such as a pool, and a second area 40, such as a spa, over a common power supply line 50 controlled by one or more electrical or light switches 75, which is preferably a single electrical or light switch. The present disclosure describes the control actuator as being a light switch 75. However, as one of ordinary skill in the art would appreciate, other actuators can be utilized to provide the power signal pattern to the particular areas based upon which the system 10 is controlled. Additionally, the present disclosure also contemplates system 10 having a single area for control of the lighting fixtures 80, as well as more than two areas.

In order to control the illumination of the first and second areas 30, 40 separately, one or more light fixtures 80 in the first area 30 can be configured to respond differently than one or more light fixtures in the second area 40 to at least one or more electrical signal patterns transmitted over the common power supply line 50. For example, light fixtures 80 in the first area 30 can be configured to respond to one or more particular signal patterns, while the light fixtures in the second area 40 can be configured to ignore or be unresponsive to the same signal patterns, allowing specific commands or instructions to be transmitted to different sets or groups of light fixtures. In one embodiment, such commands or instructions can include, but are not limited to, freezing or fixing the current light output of a responsive fixture 80, deactivating a responsive fixture, or any other command associated with adjusting the light output of a light fixture. Such arrangements can allow a user to provide signal patterns over the common power supply line 50 and to adjust the light output of fixtures 80 in the first area 30 without affecting the light output of the fixtures in the second area 40.

In an exemplary process for adjusting the light output in a pool 30 and an adjacent spa 40, as shown in FIG. 1, a user can adjust light output in the two areas without the need of a control console by providing only a few signal patterns. First, a user can adjust the light output of all fixtures 80 using one or more signal patterns generated using the electrical switch 75. Afterwards, the user can fix the light output of the fixtures 80 of the spa 40 using at least one additional signal pattern, for which only the fixtures in spa 40 are configured for response. The user can continue adjusting the light output for the fixtures 80 in the pool area 30 using additional signal patterns, without affecting the light output of fixtures 80 in the spa area 40. An additional signal pattern instructing all the fixtures 80 to reset to a default light output setting can also be generated to reset the system 10 or to choose a different light output scheme. Although adjustment of light output for fixtures 80 in only two areas has been described, it can be appreciated that in other arrangements, by configuring the control modules of the fixtures in each area to recognize different signal patterns, multiple lighting areas can be defined without the use of a control console or a lighting network. It should be further understood that the particular areas under control can be varied and is not limited to pools and spas, but can include any area that requires control of its devices, such as light fixtures 80.

The light fixture 80 can be various types of light sources providing various light output and having various control modules that can detect the power pattern signals being generated by the light switch 75. In a preferred embodiment, light fixture 80 is a light fixture having a light engine. As used herein, a light engine is any optical system that can collect light from a lamp, such as light emitting diode (LED), and deliver the light to a target, which can be used by the target or can be reformatted, such as improving spatial, angular and/or spectral uniformities of the light. Additionally, the light engines can feature one or more LED's, which can all be a single color or can be various colors. The LED light engine can be a BL-4000 RGB light engine available from Lamina Ceramics of Westhampton, N.J., which is configured with multiple LED's in an array. In the RGB light engine, each cavity contains multiple red, green and blue LED dies for optimal color uniformity. The high brightness LED's can be combined with a multilayer low temperature co-fired ceramic on metal (LTCC-M). The LTCC-M allows multiple LED's to be densely clustered to achieve high luminous intensity in a small array. The LED dies can be operated in any combination to emit a large number of colors, and the colors can be changed at will using a suitable control system. It will of course be appreciated that any number of LED's can be used, and that any suitable LED array, light engine or other light source may be employed in the present invention.

The light engine can be a LED light engine delivering any number of lumens of warm white light, blended RGB and white at any temperature, such as, for example, 95 lumens of warm white light, 120 lumens of blended RGB and 120 lumens in white (5500° K.) from a single point. The light engine can have a round footprint, standardized drive currents for ease of retrofitting and assembly, three channel control with independent input /output, an isolated metal base and a heat sink. It will of course be appreciated that any number of LED's can be used, and that any suitable LED array or light engine may be employed in the present invention. The light engine can be attached to the heat sink with conductive epoxy or other connecting techniques such as a screw connection with thermal grease applied thereto or other connection structures, materials and techniques. Mounting holes and the like can be provided on the light engine to facilitate assembly with the light feature.

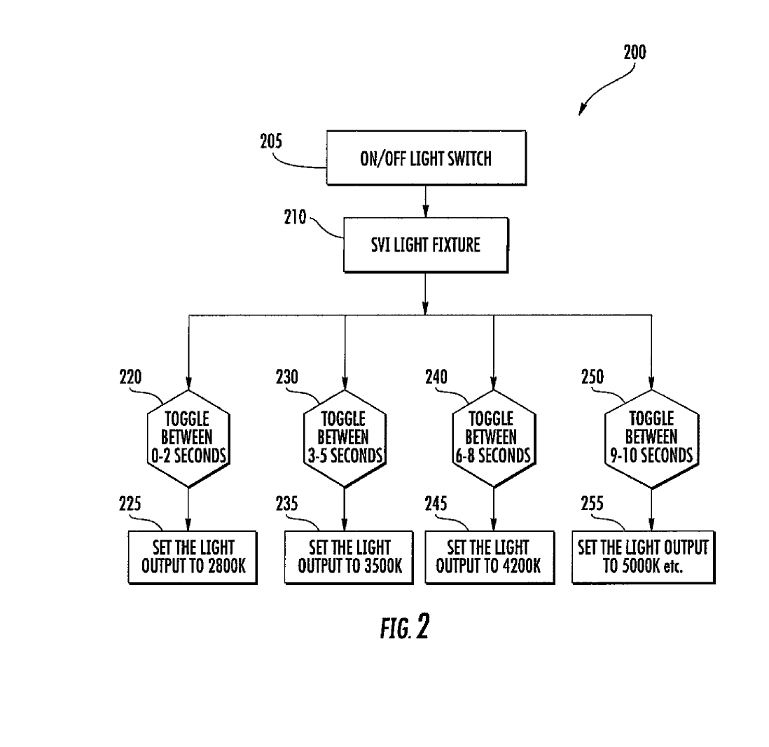

Referring to FIG. 2, a control process that can be used with system 10 of FIG. 1 is shown and generally represented by reference numeral 200. Process 200 has light switch 75 coupled with power source 20 in step 205 and further coupled with one or more light fixtures 80 in step 210. In one embodiment, the light switch 75 can be toggled repeatedly over a pre-determined period of time to control the light output of the light fixture 80. For example, in step 220 the light switch 75 can be toggled repeatedly for 0 to 2 seconds resulting in an output color corresponding to 2800K as in step 225. In step 230, the light switch 75 can be toggled repeatedly for 3 to 5 seconds resulting in an output color corresponding to 3500K as in step 235. In step 240, the light switch 75 can be toggled repeatedly for 6 to 8 seconds resulting in an output color corresponding to 4200K as in step 245. In step 250, the light switch 75 can be toggled repeatedly for 9 to 10 seconds resulting in an output color corresponding to 5000K as in step 255.

Of course, the present disclosure contemplates the use of other numbers of toggles and other time periods, as well as other outputs for those number of toggles and/or time periods. The present disclosure also contemplates the number of toggles and/or the time period being adjustable by a user. In one embodiment, a user can designate a particular light output for a particular number of toggles over a particular time period. Process 200 allows a user to observe the changes in the light output as the time period goes from a first pre-determined period (e.g., 0-2 seconds) to a second pre-determined period (3-5 seconds). Through use of multiple toggles, a user is provided greater forgiveness in selecting a particular output as opposed to each toggle representing one light output.

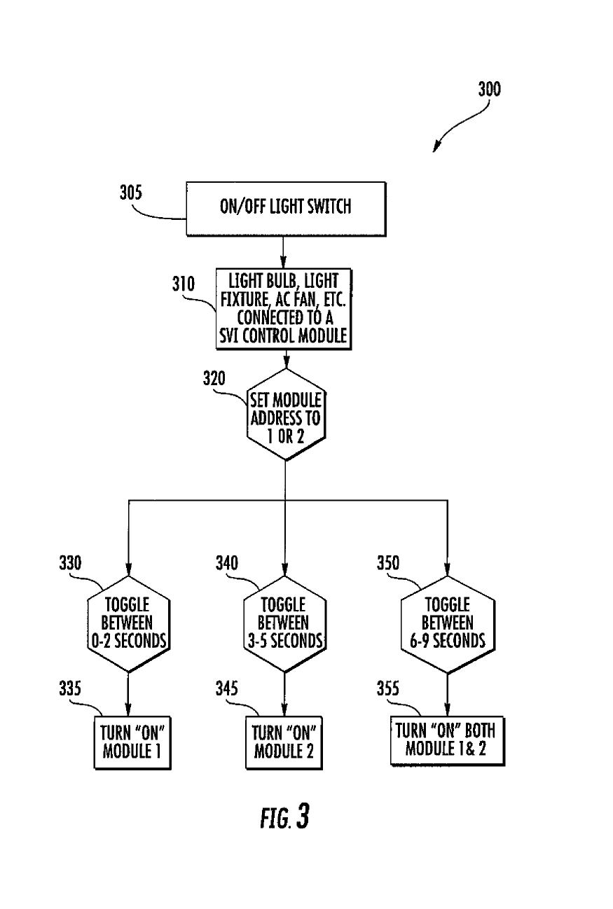

Referring to FIG. 3, a control process that can be used with system 10 of FIG. 1 is shown and generally represented by reference numeral 300. Process 300 has light switch 75 coupled with power source 20 in step 305 and further coupled with a control module, in step 310. The control module is connected to one or more light fixtures 80 or other system devices, such as a fan or sound generating device. In one embodiment, the control module can be set or adjusted to a particular address, such as address one or two, in step 320. The light switch 75 can be toggled repeatedly over a pre-determined period of time to control the light output of the light fixture 80 or output of other system devices. For example, in step 330 the light switch 75 can be toggled repeatedly for 0 to 2 seconds resulting in output being provided at module address one as in step 335. In step 340, the light switch 75 can be toggled repeatedly for 3 to 5 seconds resulting in an output being provided at module address two as in step 345. In step 350, the light switch 75 can be toggled repeatedly for 6 to 9 seconds resulting in an output being provided at both module address one and two as in step 355.

Of course, the present disclosure contemplates the use of other time periods and other outputs for one or more of those time periods. Process 300 has been described with respect to only two addresses for the module thereby controlling only two, or two sets of, devices. Of course, the present disclosure contemplates the use of any number of module addresses to be utilized controlling any number of devices or sets of devices. Process 300 can also provide various combinations of those addresses being provided with output. The particular addresses for the devices or sets of devices can also be customized to facilitate setting of the control. In one embodiment, the control modules of the one or more light fixtures 80 or other system devices can be toggled for predetermined time periods to pass through multiple light outputs for each address before moving to the next address.

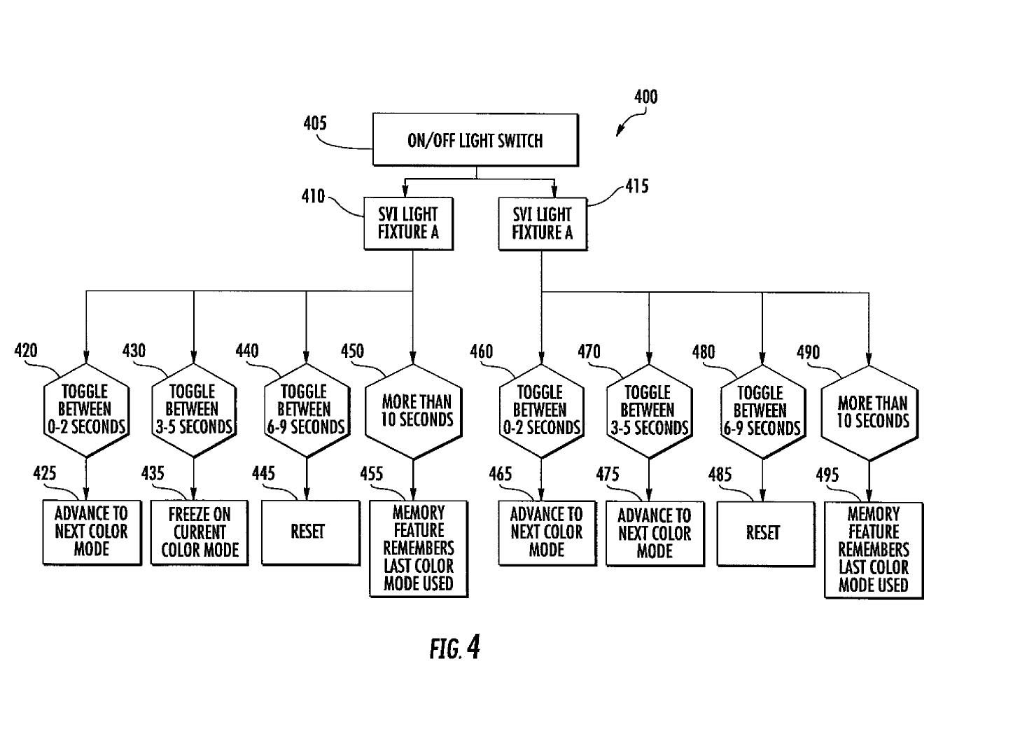

Referring to FIG. 4, a control process that can be used with system 10 of FIG. 1 is shown and generally represented by reference numeral 400. Process 400 has light switch 75 coupled with power source 20 in step 405 and further coupled with first and second light fixtures 80 or other system devices in steps 410, 415. In one embodiment, the light switch 75 can be toggled repeatedly over a pre-determined period of time to control the light output of the first and second light fixtures 80. For example, in step 420 the light switch 75 can be toggled repeatedly for 0 to 2 seconds to advance the first light fixture 80 to the next color mode as in step 425. In step 430, the light switch 75 can be toggled repeatedly for 3 to 5 seconds to freeze the first light fixture 80 on the current color mode as in step 435. In step 440, the light switch 75 can be toggled repeatedly for 6 to 9 seconds to reset the color mode of the first light fixture 80 as in step 445. In step 450, the light switch 75 can be toggled repeatedly for 10 or more seconds to utilize a memory feature that remembers the last color mode used for the first light fixture 80 as in step 455.

Similarly, in step 460 the light switch 75 can be toggled repeatedly for 0 to 2 seconds to advance the second light fixture 80 to the next color mode as in step 465. In step 470, the light switch 75 can be toggled repeatedly for 3 to 5 seconds to freeze the second light fixture 80 on the current color mode as in step 475. In step 480, the light switch 75 can be toggled repeatedly for 6 to 9 seconds to reset the color mode of the second light fixture as in step 485. In step 490, the light switch 75 can be toggled repeatedly for 10 or more seconds to utilize a memory feature that remembers the last color mode used for the second light fixture as in step 495. Of course, the present disclosure contemplates the use of other time periods and other outputs for one or more of those time periods. In one embodiment, different time periods are utilized to adjust different light fixtures 80 so that process 400 can provide different outputs to each of the two or more light fixtures or other devices based upon the power interruption pattern. In another embodiment, the light fixtures 80 or other system devices are grouped together and process 400 provides different outputs to each of the groups based upon different time periods being designated for each of the groups.

In one embodiment, light switch 75 can be used to synchronize and/or unsynchronize multiple lighting devices 80 or other system devices, such as water features or sound generating devices. In a synchronized state, the lighting devices 80 or other system devices can be toggled to the same or related output, such as a color mode for a light fixture, and can stay synchronized to each other if switched during a particular period of time. In an unsynchronized state, one set or type of light fixtures 80 or other system devices can go to one color mode or output and another set or type of light fixtures or other system devices can go to a different color mode or output if switched during a particular period of time. In another embodiment, in the synchronized state, the light fixtures can all follow the same color sequence(s) over a period of time as measured by various devices and techniques, including an AC zero crossing detection circuit, an internal microprocessor timer, and a real-time clock circuit.

In yet another embodiment, light switch 75 can be used to select pre-defined dimming levels for one or more of the lighting fixtures 80 on power circuit 50. For example, when the light switch 75 is initially turned on, the power provided to the particular light fixture 80 is at 100%. Following the first toggle, the power provided to the particular light fixture 80 is reduced to provide dimming of 75%. Additional toggles can cause further dimming of the one or more lighting fixtures 80. The amount of dimming and/or the number of toggles can be varied to provide differing degrees of control. The power reduction for one or more of the light fixtures 80 or other system devices can also be implemented by monitoring a number of toggles over a pre-determined time period.

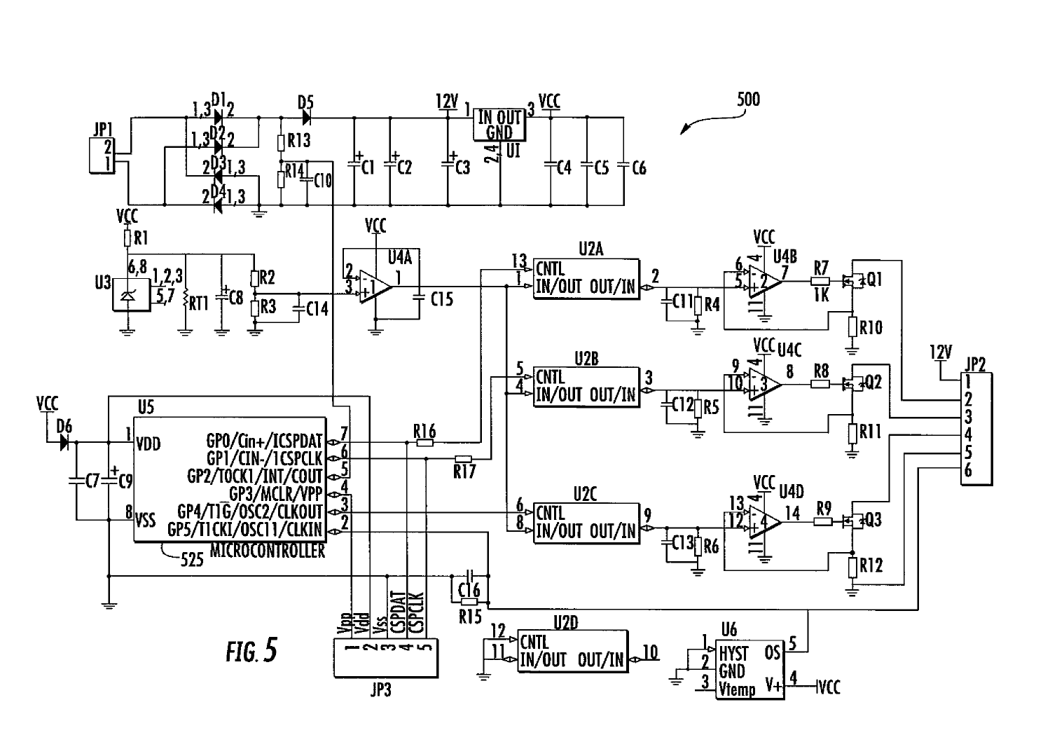

Referring to FIG. 5, an exemplary power and control circuit is shown and generally represented by reference numeral 500. Circuit 500 can be used to implement the control process 200 described with respect to FIG. 2. Of course, it should be understood that the present disclosure contemplates the use of other circuits and components to implement one or more of the steps of process 200. The circuit 500 can be incorporated into a control module or the like which is operably coupled with one or more of the light fixtures 80 or other system devices. In one embodiment, the control module and circuit 500 are integrally formed with or incorporated into the light fixture 80 to provide a single device. Circuit 500 can utilize a microcontroller 525 configured with various components including transistors, capacitors, diodes, resistors and op-amps in order to vary the output of the one or more light fixtures 80 or other system devices based upon the number of power interruptions over a pre-determined period of time.

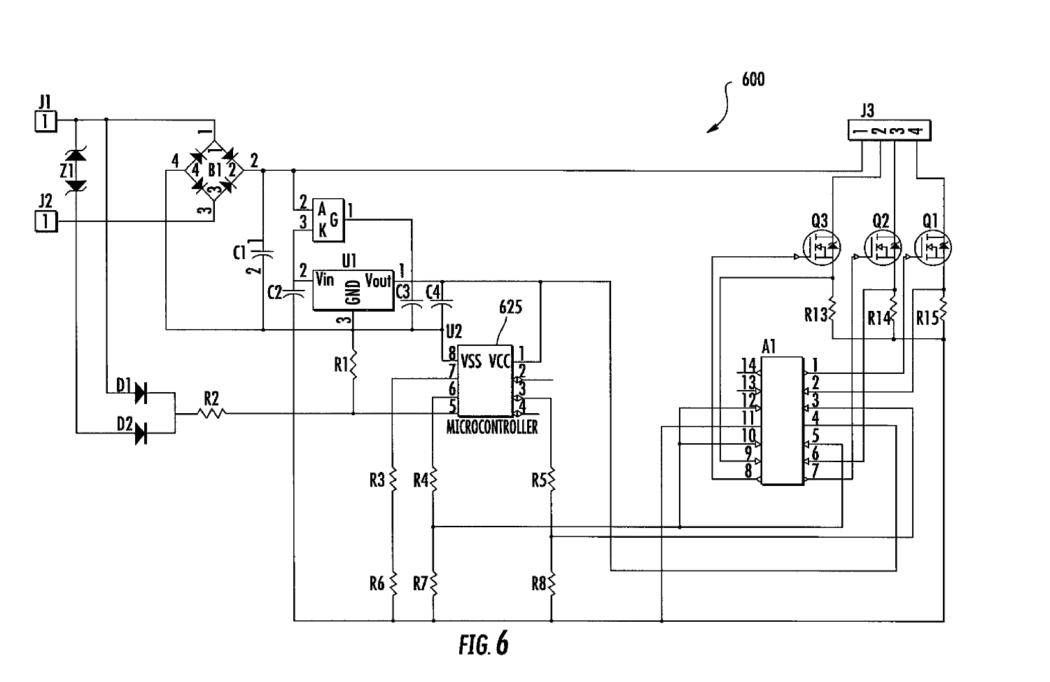

Referring to FIG. 6, another exemplary power and control circuit is shown and generally represented by reference numeral 600. Circuit 600 can be used to implement the control process 200 described with respect to FIG. 2. Of course, it should be understood that the present disclosure contemplates the use of other circuits and components to implement one or more of the steps of process 200. The circuit 600 can be incorporated into a control module or the like which is operably coupled with one or more of the light fixtures 80 or other system devices. In one embodiment, the control module and circuit 600 are integrally formed with or incorporated into the light fixture 80 to provide a single device. Circuit 600 can utilize a microcontroller 625 configured with various components including transistors, capacitors, diodes, resistors and a rectifier in order to vary the output of the one or more light fixtures 80 or other system devices based upon the number of power interruptions over a pre-determined period of time.

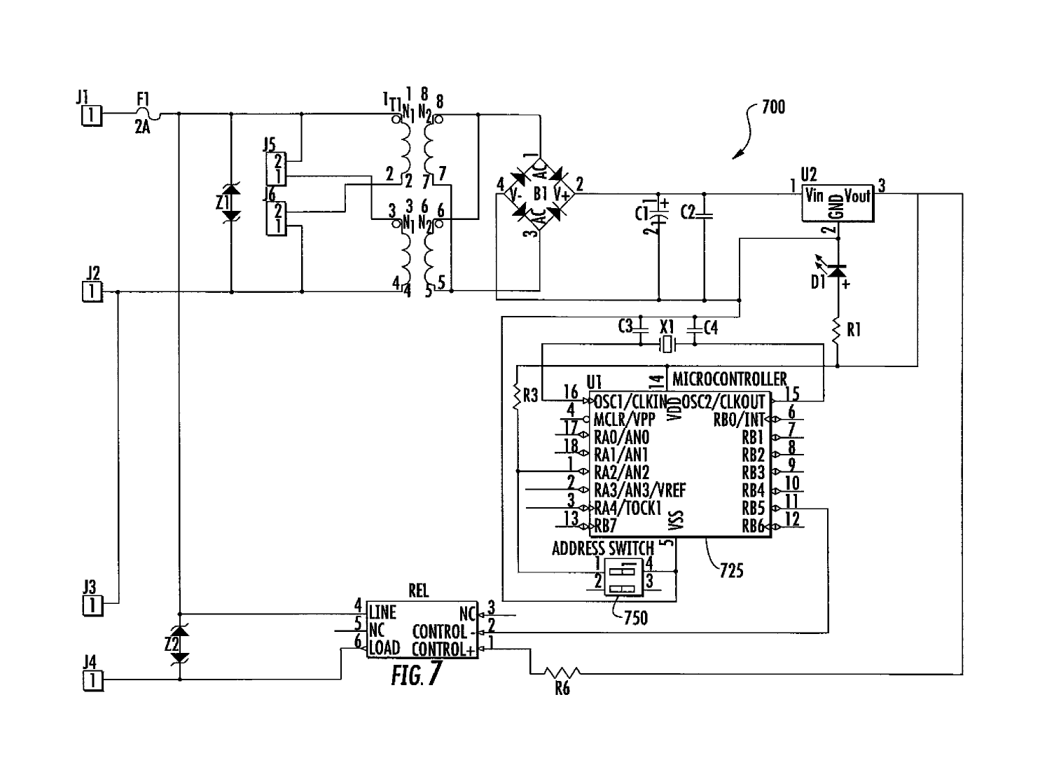

Referring to FIG. 7, an exemplary power and control circuit is shown and generally represented by reference numeral 700. Circuit 700 can be used to implement the control process 300 described with respect to FIG. 3. Of course, it should be understood that the present disclosure contemplates the use of other circuits and components to implement one or more of the steps of process 300. The circuit 700 can be incorporated into a control module or the like which is operably coupled with one or more of the light fixtures 80 or other system devices. In one embodiment, the control module and circuit 700 are integrally formed with or incorporated into the light fixture 80 to provide a single device. Circuit 700 can utilize a microcontroller 725 configured with various components including an address switch 750, capacitors, diodes, resistors, inductors and a rectifier in order to vary the output of the one or more light fixtures 80 or other system devices at a designated module address based upon the number of power interruptions over a pre-determined period of time.

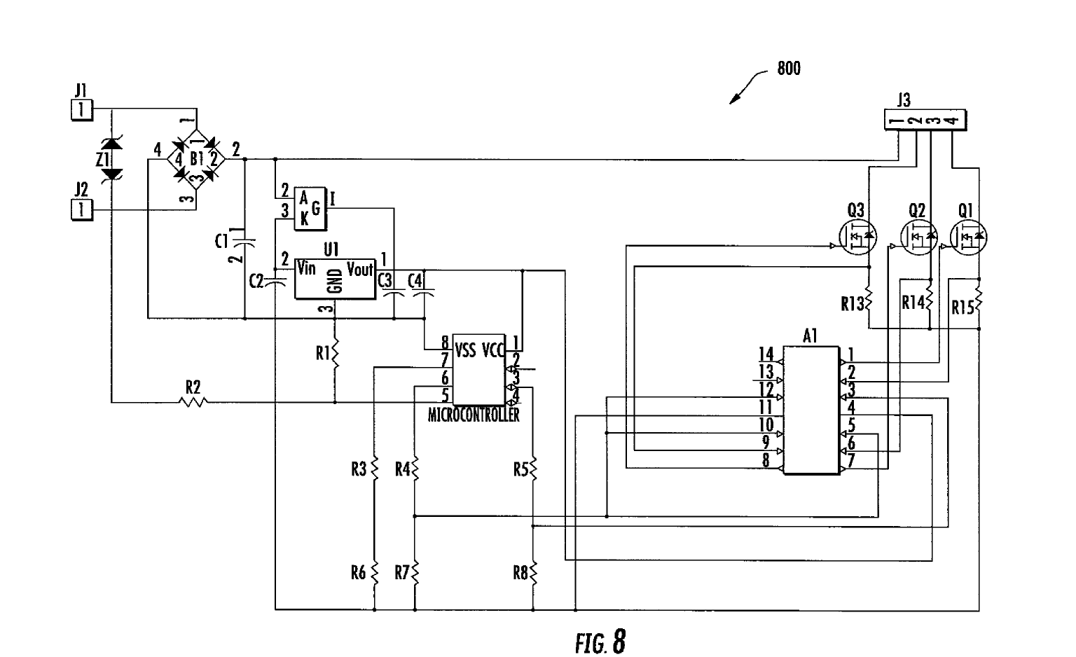

Referring to FIG. 8, an exemplary power and control circuit is shown and generally represented by reference numeral 800. Circuit 800 can be used to implement the control process 400 described with respect to FIG. 4. Of course, it should be understood that the present disclosure contemplates the use of other circuits and components to implement one or more of the steps of process 400. The circuit 800 can be incorporated into a control module or the like which is operably coupled with one or more of the light fixtures 80 or other system devices. In one embodiment, the control module and circuit 800 are integrally formed with or incorporated into the light fixture 80 to provide a single device. Circuit 800 can utilize a microcontroller 825 configured with various components including transistors, capacitors, diodes, resistors and a rectifier in order to vary the output of the one or more light fixtures 80 or other system devices based upon the number of power interruptions over a pre-determined period of time. For example, the light fixture 80 can be advanced to the next color mode, frozen on the current color mode, reset, and/or set to the last color mode used. Additionally, circuit 800 allows a set of lights or a subset thereof to be synchronized or unsynchronized.

The present disclosure describes systems and methods of controlling light fixtures 80 and/or other system devices. It should be understood that various entertainment components can be used with system 10 and controlled by the embodiments described herein, including LED water features, such as, LED laminar components, waterfall components and bubbler components; LED above-ground light fixtures, such as, landscape lights, flood lights and accent tubes; underwater LED fixtures, such as light fixtures, lights and fountain lights; LED light sources for fiber optics, such as, source, source and tower illuminator; and other LED fixtures, such as well lights, stairway lighting, down lights and LED node lights. These components can be used in various configurations to provide an aesthetically pleasing display. Other components can be used with system 10 and controlled by the embodiments described herein such as those described in co-pending and commonly owned U.S. patent application Ser. No. 11/066,501 filed Feb. 25, 2005, U.S. patent application Ser. No. 11/265,691 filed Nov. 1, 2005 and U.S. patent application Ser. No. 11/265,692 filed Nov. 1, 2005, the disclosures of which are herein incorporated by reference.

The entertainment components used in system 10 can be in communication with a control system operating in compliance with the DMX512, DMX512/1990 or DMX512-A protocols, or any extensions thereof. These protocols can specify the transmission voltages, the data rate, the format of the data content, the type of cable and the type of connector to be used. The DMX protocols additionally can be used to specify the color of the light output by the light engine, which may change over time or in a programmed sequence to give a pleasing effect from the light fixture 80, as well as the other entertainment components. It will of course be appreciated that the present disclosure is not limited to the use of DMX protocols, and that any suitable control module protocol can be used. The control system can have a processor, microprocessor or computer in communication with a DMX controller and an audio controller (e.g., a Symphony Of Light™ controller). The DMX controller can receive inputs or commands from one or more of a touch screen interface, a keypad and/or a remote control. The audio controller can be connected to a music source such as a radio for synchronization of music with the other entertainment components, e.g., light fixtures 80. Individual music compositions can be input to the control system for synchronization with the light effects controlled by the DMX controller.

In the embodiments of the invention discussed above, various processors and controllers can be utilized and implemented in numerous ways, such as with dedicated hardware, or using one or more processors (e.g., microprocessors) that are programmed using software (e.g., microcode) to perform the various functions discussed above. Similarly, storage devices can be implemented in numerous ways, such as, but not limited to, RAM, ROM, PROM, EPROM, EEPROM, CD, DVD, optical disks, floppy disks, magnetic tape, and the like.

For purposes of the present disclosure, the term “LED” refers to any diode or combination of diodes that is capable of receiving an electrical signal and producing a color of light in response to the signal. Thus, the term “LED” as used herein should be understood to include light emitting diodes of all types (including semi-conductor and organic light emitting diodes), semiconductor dies that produce light in response to current, light emitting polymers, electro-luminescent strips, and the like. Furthermore, the term “LED” may refer to a single light emitting device having multiple semiconductor dies that are individually controlled. It should also be understood that the term “LED” does not restrict the package type of an LED; for example, the term “LED” may refer to packaged LEDs, non-packaged LEDs, surface mount LEDs, chip-on-board LEDs, and LEDs of all other configurations. The term “LED” also includes LEDs packaged or associated with other materials (e.g., phosphor, wherein the phosphor may convert radiant energy emitted from the LED to a different wavelength).

Additionally, as used herein, the term “light source” should be understood to include all illumination sources, including, but not limited to, LED-based sources as defined above, incandescent sources (e.g., filament lamps, halogen lamps), pyro-luminescent sources (e.g., flames), candle-luminescent sources (e.g., gas mantles), carbon arc radiation sources, photo-luminescent sources (e.g., gaseous discharge sources), fluorescent sources, phosphorescent sources, high-intensity discharge sources (e.g., sodium vapor, mercury vapor, and metal halide lamps), lasers, electro-luminescent sources, cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers capable of producing primary colors.

For purposes of the present disclosure, the term “light output” should be understood to refer to the production of a frequency (or wavelength) of radiation by an illumination source (e.g., a light source) or the intensity of an illumination source. Furthermore, as used herein, the term “color” should be understood to refer to any frequency (or wavelength) of radiation within a spectrum; namely, “color” refers to frequencies (or wavelengths) not only in the visible spectrum, but also frequencies (or wavelengths) in the infrared, ultraviolet, and other areas of the electromagnetic spectrum.

For purposes of the present disclosure, the term “water feature” is used generally to describe a vessel containing a liquid (e.g., water), that may be used for any number of utilitarian, decorative, entertainment, recreational, therapeutic, or sporting purposes. As used herein, a water may be for human use (e.g., swimming, bathing) or may be particularly designed for use with wildlife (e.g., an aquarium for fish, other aquatic creatures, and/or aquatic plant life). Additionally, a water feature may be man made or naturally occurring and may have a variety of shapes and sizes. Furthermore, a water feature may be constructed above ground or below ground, and may have one or more discrete walls or floors, one or more rounded surfaces, or combinations of discrete walls, floors, and rounded surfaces. Accordingly, it should be appreciated that the term “water feature” as used herein is intended to encompass various examples of water containing vessels such as, but not limited to pools, spas, tubs, sinks, basins, baths, tanks, fish tanks, aquariums and the like.

Similarly, for purposes of the present disclosure, the term “pool” or “spa” is used herein to describe a type of water feature that is particularly designed for a variety of entertainment, recreational, therapeutic purposes and the like. Some other commonly used terms for a spa include, but are not limited to, “hot-tub” and “whirlpool bath.” Generally, a pool or spa may include a number of accessory devices, such as one or more heaters, blowers, jets, circulation and filtration devices to condition water in the water feature, as well as one or more light sources to illuminate the water therein. For purposes of the present disclosure, it also should be appreciated that a water feature as described above may be divided up into one or more sections, and that one or more of the water feature sections can be particularly adapted for use as a spa or a pool.

While the exemplary embodiment of system 10 describes differentiating signals based upon interruptions of power, it should be understood that signal differentiation can be based on other power parameters such as changes in voltage and/or current. These parameters can be recognized by the control modules and result in varying responses by the light fixtures. The present disclosure also contemplates different parameters being used in combination with each other to establish electrical power signal patterns that are recognizable by the control modules. The exemplary embodiments described herein can use zero crossing counting techniques to control the light fixtures 80 or other system devices, although other techniques are contemplated by the present disclosure including the use of RC timing circuits. The control system described herein can change a lighting or entertainment pattern between synchronous and non-synchronous, as well as resetting of one or more of the light fixtures based upon the use of a single light switch, but multiple switches are also contemplated. In system 10, the number of set color temperatures, timing periods and/or number of light fixtures can be dependent upon the product and/or the application. The control systems and processes described herein can be retrofitted to existing circuit through use of the existing circuits power lines and switches.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

We claim:

1. A lighting system comprising:
at least one light source to generate variable light output; and
at least one controller coupled to the at least one light source to control the variable light output based on a number of interruptions of power supplied to the at least one light source over a pre-determined time period.

2. The system of claim 1, wherein the variable light output is a light temperature.

3. The system of claim 1, wherein the at least one light source is a plurality of light sources, wherein the at least one controller comprises a plurality of addresses, and wherein each of the addresses designates one or more of the plurality of light sources to be controlled.

4. The system of claim 1, wherein the at least one light source is a plurality of light sources, and wherein the at least one controller selectively synchronizes and unsynchronizes the plurality of light sources.

5. The system of claim 1, wherein the at least one controller further comprises a memory element having a plurality of light output settings stored therein for the at least one light source.

6. The system of claim 1, wherein the at least one light source is an LED light engine.

7. The system of claim 1, wherein the at least one controller resets the at least one light source to a default light output based on one of the number of interruptions of power over the pre-determined time period.

8. The system of claim 1, wherein the number of interruptions of power supplied to the at least one light source over the pre-determined time period can be adjusted.

9. A method of controlling output in an entertainment system, the method comprising:
providing power to at least one entertainment device;
interrupting the power a number of times;
monitoring the at least one entertainment device to determine a number of power interruptions over a pre-determined time period; and
varying the output of the at least one entertainment device based upon the number of power interruptions over the pre-determined time period.

10. The method of claim 9, wherein the at least one entertainment device is a light fixture.

11. The method of claim 10, wherein the output is a light temperature.

12. The method of claim 10, further comprising designating one or more of a plurality of light fixtures to be controlled.

13. The method of claim 10, wherein the varying of the output comprises synchronizing and unsynchronizing a plurality of light fixtures.

14. The method of claim 10, further comprising storing a plurality of light output settings in a memory.

15. The method of claim 10, wherein the light fixture is an LED light engine.

16. The method of claim 10, wherein the varying of the output comprises resetting the output to a default light output based on one of the number of power interruptions over the pre-determined time period.

17. A lighting device for a lighting system, the device comprising:
a light engine coupled to a power source and capable of providing variable light output;
a controller connected to the light engine and in communication with the power source for detecting a number of power interruptions over a pre-determined time period, wherein the controller varies the light output of the light engine based at least in part on the number of power interruptions over the pre-determined time period.

18. The device of claim 17, wherein the controller further comprises a memory element having a plurality of light output settings stored therein for the light engine.

19. The device of claim 17, wherein the light engine comprises at least one LED.

20. The device of claim 17, wherein the controller resets the light engine to a default light output based on one of the number of power interruptions over the pre-determined time period.
